(19) United States
(12) Patent Application Publication
(10) Pub. No.: US 2026/0254112 A1
(43) Pub. Date: Aug. 27, 2026

(54) PHASED ARRAY ANTENNA MODULE

(71) Applicant: Fujikura Ltd., Tokyo (JP)

(72) Inventors: Lei Xu, Sakura-shi (JP); Hideyuki Wada, Sakura-shi (JP)

(73) Assignee: Fujikura Ltd., Tokyo (JP)

(21) Appl. No.: 19/546,764

(22) Filed: Feb. 23, 2026

(30) Foreign Application Priority Data
Feb. 27, 2025 (JP) 2025-029994

(51) Int. Cl. H01Q 3/38; H01Q 21/24

(52) U.S. Cl. CPC H01Q 3/38; H01Q 21/24

(57) ABSTRACT

A phased array antenna module include: a plurality of antenna elements; and a phase adjuster configured to set a beam direction of any one or both of the transmission wave and the reception wave by adjusting a phase of any one or both of a transmission signal supplied to each of the plurality of antenna elements and a reception signal output from each of the plurality of antenna elements, and to perform any one or both of setting of the transmission wave to a circularly polarized wave and setting for receiving the reception wave as the circularly polarized wave. The phase adjuster includes a first phase adjuster and a second phase adjuster, a phase adjustment resolution of the first phase adjuster is smaller than that of the second phase adjuster, and a mounting area of the first phase adjuster is larger than that of the second phase adjuster.

### CROSS-REFERENCE TO RELATED APPLICATION

Priority is claimed on Japanese Patent Application No. 2025-029994, filed Feb. 27, 2025, the content of which is incorporated herein by reference.

### BACKGROUND OF THE INVENTION

### Field of the Invention

The present invention relates to a phased array antenna module.

### Description of Related Art

Japanese Patent No. 7133532 discloses an antenna device in which circular polarization characteristics are improved. The antenna device includes four first to N-th circular polarization antennas disposed in a planar shape, and a phase adjustment circuit that adjusts a phase relationship between first to N-th signals transmitted from the first to N-th circular polarization antennas or first to N-th signals received by the first to N-th circular polarization antennas, and radiates a circularly polarized radio wave by providing a phase difference of 90° to each of the first to N-th signals.

### SUMMARY OF THE INVENTION

However, in order to generate a circularly polarized radio wave, it is necessary to control a phase difference between first to N-th signals in a phase adjustment range of 360° as a whole.

On the other hand, in a case where beam forming is to be performed for a circularly polarized radio wave, it is necessary to control a phase difference with a fine step width in a phase adjustment range narrower than the above-described phase adjustment range, depending on communication frequencies. For example, beam forming is required to set a beam direction with a step width of about 5° in a variable range of a beam direction of about 0° to 70°.

However, although such setting of a beam direction can be performed by using a single phase shifter, in order to perform beam forming and circular polarization at the same time, it is necessary to expand a phase adjustment range to 360°, and accordingly, in a case where the setting is performed by using the single phase shifter, it is necessary to significantly increase a mounting area of the phase shifter. That is, in a case where the circular polarization and the beam forming are to be performed by a phase shifter for beam forming, a mounting area of the phase shifter increases, and mounting is difficult.

The present invention is made in view of the above-described circumstances, and an object of the present invention is to provide a phased array antenna module that can save a mounting area.

In the present invention, as a first aspect according to a phased array antenna module, the phased array antenna module includes a plurality of antenna elements configured to perform any one or both of radiation of a transmission wave and capture of a reception wave, and a phase adjuster configured to set a beam direction of any one or both of the transmission wave and the reception wave by adjusting a phase of any one or both of a transmission signal supplied to each of the plurality of antenna elements and a reception signal output from each of the plurality of antenna elements, and to perform any one or both of setting of the transmission wave to a circularly polarized wave and setting for receiving the reception wave as the circularly polarized wave. The phase adjuster includes a first phase adjuster and a second phase adjuster, a phase adjustment resolution of the first phase adjuster is smaller than a phase adjustment resolution of the second phase adjuster, and a mounting area of the first phase adjuster is larger than a mounting area of the second phase adjuster.

In the present invention, as a second aspect according to the phased array antenna module, in the first aspect, in the first phase adjuster, a plurality of delay units that impart a unit delay amount may be connected in series, and the delay unit may be switched between a state in which the unit delay amount is imparted and a state in which the unit delay amount is not imparted.

In the present invention, as a third aspect according to the phased array antenna module, in the first or second aspect, the second phase adjuster may be a phase inverter.

In the present invention, as a fourth aspect according to the phased array antenna module, in any one of the first to third aspects, the antenna element may include an antenna element for horizontal polarization and an antenna element for vertical polarization.

In the present invention, as a fifth aspect according to the phased array antenna module, in any one of the first to fourth aspects, the plurality of antenna elements may be orthogonally arranged in a horizontal direction and a vertical direction.

According to the present invention, it is possible to provide a phased array antenna module that can save a mounting area.

### BRIEF DESCRIPTION OF THE DRAWINGS

FIG. 1 is a block diagram showing the entire configuration of a phased array antenna module according to one embodiment of the present invention.

FIG. 2 is a front view of an array antenna in one embodiment of the present invention.

FIG. 3 is a block diagram showing the configuration of a beam former integrated circuit in one embodiment of the present invention.

FIG. 4 is a block diagram showing a detailed configuration of a phase shifter in one embodiment of the present invention.

FIG. 5 is a schematic diagram showing a setting principle of a beam direction in one embodiment of the present invention.

FIG. 6 is a characteristic diagram showing phase characteristics of a phase shifter in one embodiment of the present invention.

FIG. 7A is a schematic diagram showing a generation principle of a circularly polarized wave in one embodiment of the present invention.

FIG. 7B is a schematic diagram showing a generation principle of a circularly polarized wave in one embodiment of the present invention.

FIG. 8 is a table showing a PS required number and a PI required number according to a phase change amount in one embodiment of the present invention.

FIG. 9A is a characteristic diagram showing an axial ratio of a phased array antenna module according to one embodiment of the present invention.

FIG. 9B is a characteristic diagram showing an axial ratio of a phased array antenna module according to one embodiment of the present invention.

### DETAILED DESCRIPTION OF THE INVENTION

Hereinafter, one embodiment of the present invention will be described with reference to the drawings.

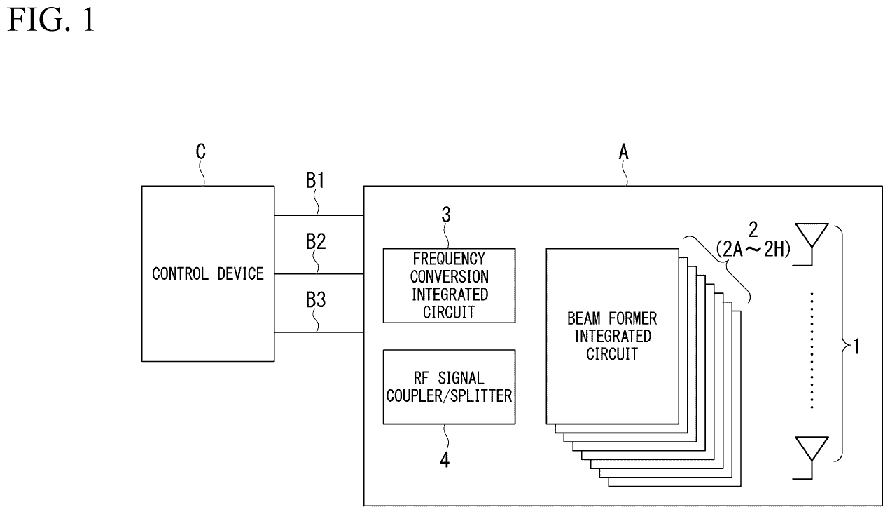

As shown in FIG. 1, a phased array antenna module A according to the present embodiment includes an array antenna 1, eight beam former integrated circuits 2A to 2H, a frequency conversion integrated circuit 3, and an RF signal coupler/splitter 4. The phased array antenna module A is provided in a wireless communication device capable of performing beam forming that can freely change a beam pattern by using, for example, a millimeter wave band.

The phased array antenna module A is connected to a control device C through a signal line B1, a control line B2, and a power line B3. That is, the phased array antenna module A performs a predetermined transmission/reception function based on various types of signals input from the control device C through the signal line B1, the control line B2, and the power line B3.

For example, an intermediate frequency (IF) signal is transmitted and received between the phased array antenna module A and the control device C through the signal line B1. In addition, a control signal is transmitted and received between the phased array antenna module A and the control device C through the control line B2. Further, power is supplied from the control device C to the phased array antenna module A through the power line B3 between the phased array antenna module A and the control device C.

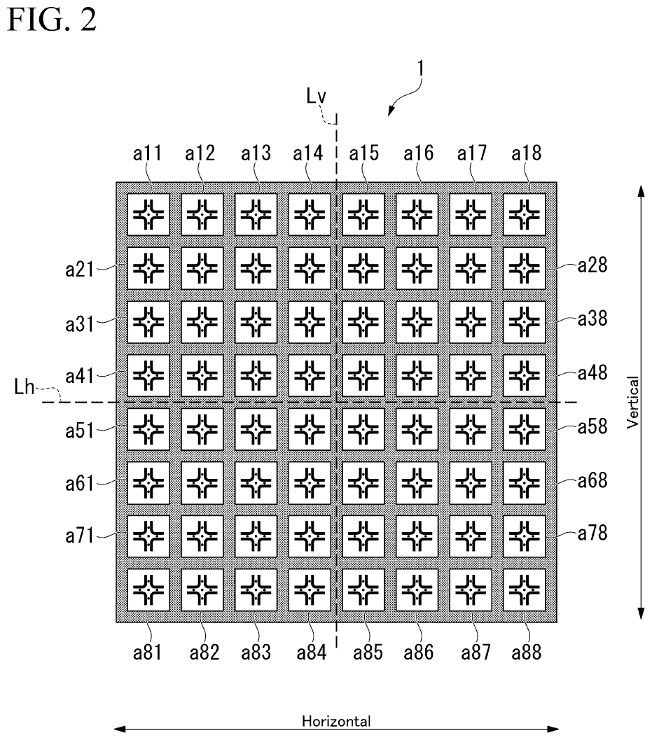

In the phased array antenna module A, the array antenna 1 is a planar antenna in which a plurality of antenna elements are disposed in a predetermined arrangement pattern. That is, as shown in FIG. 2, the array antenna 1 is formed in a square (rectangular) shape as a whole, and includes 64 11th to 88th antenna elements a11 to a88 that are orthogonally arranged in a horizontal direction and a vertical direction. The array antenna 1 performs radiation of a transmission wave and capture of a reception wave.

A reference numeral Lh in FIG. 2 denotes a central axis line (horizontal center line) in a horizontal direction of the array antenna 1, and a reference numeral Lv denotes a central axis line (vertical center line) in a vertical direction of the array antenna 1. In addition, in the following description, the 11th to 88th antenna elements a11 to a88 are collectively referred to as an antenna element a.

A total of 64 11th to 88th antenna elements a11 to a88 are orthogonally arranged in a planar array of 8 rows×8 columns. That is, the first row is composed of 11th to 18th antenna elements a11 to a18. The description of the second to seventh rows will be omitted. The eighth row is composed of 81st to 88th antenna elements a81 to a88. In addition, the first column is composed of 11th to 81st antenna elements a11 to a81. The description of the second to seventh columns are similar to the first column, and therefore their explanation will be omitted. The eighth column is composed of 18th to 88th antenna elements a18 to a88.

In a row direction and a column direction, an interval (interval between elements) between adjacent antenna elements is set to a half wavelength (λ/2) with respect to a wavelength λ of a radiated wave. That is, in relation to a total of 64 11th to 88th antenna elements a11 to a88, an arrangement interval in the row direction is a half wavelength (λ/2), and an arrangement interval in the column direction is also a half wavelength (λ/2).

The row direction of the 11th to 88th antenna elements a11 to a88 is a horizontal direction as shown in the drawing. In addition, the column direction of the 11th to 88th antenna elements a11 to a88 is a vertical direction. That is, in the three-dimensional disposition of the array antenna 1, the row direction of the 11th to 88th antenna elements a11 to a88 is set as a horizontal direction, and the column direction of the 11th to 88th antenna elements a11 to a88 is set as a vertical direction.

Here, 64 11th to 88th antenna elements a11 to a88, more specifically, are each composed of a pair of antenna elements. One of the pair of antenna elements is an antenna element for horizontal polarization, and the other is an antenna element for vertical polarization. That is, the array antenna 1 in the present embodiment includes, more specifically, 128 (=64×2) antenna elements. The antenna element for horizontal polarization and the antenna element for vertical polarization are arranged in planar arrays on different layers (two layers).

The eight beam former integrated circuits 2A to 2H are integrated circuits that control a beam direction of the array antenna 1. The eight beam former integrated circuits 2A to 2H are provided to correspond to each row of, for example, the array antenna 1 composed of 11th to 88th antenna elements a11 to a88 disposed in 8 rows×8 columns.

The first beam former integrated circuit 2A is provided to correspond to 16 11th to 18th antenna elements a11 to a18 constituting the first row. The second beam former integrated circuit 2B is provided to correspond to 16 11st to 28th antenna elements a21 to a28 constituting the second row. The description of the third to seventh beam former integrated circuits 2C to 2G will be omitted. The eighth beam former integrated circuit 2H is provided to correspond to 16 81st to 88th antenna elements a81 to a88 constituting the eighth row.

The frequency conversion integrated circuit 3 performs frequency conversion of an IF signal into an RF signal and performs frequency conversion of an RF signal into an IF signal. That is, during signal transmission, the frequency conversion integrated circuit 3 generates an RF signal having a frequency higher than the frequency of the IF signal by mixing a local signal generated by a local oscillator with the IF signal input from the control device C, and outputs the RF signal to the RF signal coupler/splitter 4. In addition, during signal reception, the frequency conversion integrated circuit 3 generates an IF signal having a frequency lower than the frequency of the RF signal by mixing the local signal with the RF signal input from the RF signal coupler/splitter 4, and outputs the IF signal to the control device C.

The RF signal coupler/splitter 4 distributes the RF signal input from the frequency conversion integrated circuit 3 to the eight beam former integrated circuits 2A to 2H. In addition, the RF signal coupler/splitter 4 adds the RF signals (reception signals) input from the eight beam former integrated circuits 2A to 2H to each other, and inputs the added signals to the frequency conversion integrated circuit 3.

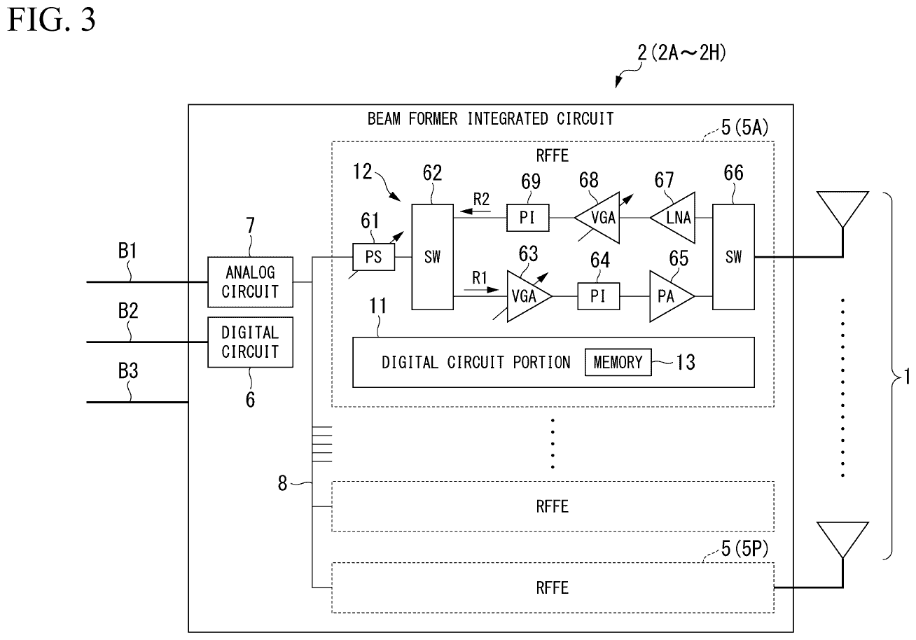

Next, detailed configurations of the above-described beam former integrated circuits 2A to 2H will be described with reference to FIG. 3. All of the eight beam former integrated circuits 2A to 2H have the same functional configuration. Therefore, in the following, the eight beam former integrated circuits 2A to 2H are collectively referred to as a beam former integrated circuit 2.

The beam former integrated circuit 2 includes 16 RF front ends 5A to 5P, a digital circuit 6, an analog circuit 7, and an RF signal coupler/splitter 8. Since all of the 16 RF front ends 5A to 5P have the same functional configuration, the 16 RF front ends 5A to 5P will be collectively referred to as an RF front end 5 in the following description.

In the beam former integrated circuit 2, each of the 16 RF front ends 5A to 5P is individually connected to 16 antenna elements a constituting one row such that one or the other of a pair of antenna elements constituting one antenna element a corresponds to one RF front end 5 in a one-to-one relationship.

For example, the first RF front end 5A is connected to one (for horizontal polarization) of the 11th antenna elements a11 in the first row and the first column. The second RF front end 5B is connected to one (for horizontal polarization) of the 12th antenna elements a12 in the first row and the second column. The description of the third RF front end 5B to the seventh RF front end 5G will be omitted. The eighth RF front end 5H is connected to one (for horizontal polarization) of the 18th antenna elements a18 in the first row and the eighth column.

In addition, the ninth RF front end 5I is connected to the other (for vertical polarization) of the 11th antenna elements a11 in the first row and the first column. The tenth RF front end 5J is connected to the other (for vertical polarization) of the 12th antenna element a12 in the first row and the second column. The description of the eleventh to fourteenth RF front ends 5K to 5O will be omitted. The 16th RF front end 5P is connected to the other (for vertical polarization) of the 18th antenna element a18 in the first row and the eighth column.

That is, among the 16 RF front ends 5A to 5P, the first to eighth RF front ends 5A to 5H control a beam direction during transmission and reception of a horizontally polarized wave in the array antenna 1 as a whole. On the other hand, the ninth to 16th RF front ends 5I to 5P control a beam direction during transmission and reception of a vertically polarized wave in the array antenna 1 as a whole.

As shown in FIG. 3, the RF front end 5 includes a digital circuit portion 11 and an analog circuit portion 12. The digital circuit portion 11 transmits and receives a control signal to and from the control device C through the control line B2. The digital circuit portion 11 controls the RF front end 5 based on the control signal received from the control device C.

A control signal is transmitted and received between the phased array antenna module A and the control device C by parallel communication through the control line B2. That is, the digital circuit portion 11 transmits and receives the control signal to and from the control device C by the parallel communication. A communication method between the phased array antenna module A and the control device C is not limited to the parallel communication. Serial communication such as a serial peripheral interface (SPI) or an inter-integrated circuit (I2C) may be adopted.

The digital circuit portion 11 is connected to the digital circuit 6 by a wiring line in the beam former integrated circuit 2. The digital circuit 6 relays the communication performed between the digital circuit portion 11 and the control device C. In addition, the digital circuit 6 communicates with the digital circuit portion 11 based on a control signal received from the control device C.

One communication transaction transmitted from the control device C to the phased array antenna module A includes additional information, a command, and data. The communication transaction has a fixed bit length. The command is a register address in a case where an instruction to perform writing to a register or reading from the register is provided. Alternatively, the command is a numerical value indicating an operation instruction to the beam former integrated circuit 2 or the RF front end 5. The command and the data have fixed lengths. In the present embodiment, the command has 8 bits and the data has 16 bits.

The digital circuit portion 11 includes a memory 13 that is a storage area for storing a beam table BT used for beam forming. The beam table BT is a look-up table in which a plurality of combinations of a phase shift amount setting value and an intensity setting value set according to a beam direction of the array antenna 1 to be controlled are stored. For example, a beam table in which 2048 combinations of a phase shift amount setting value and an intensity setting value are defined is stored in the memory 13.

The beam table BT is written to the memory 13 or read from the memory 13 by using an address of 11 bits. For example, the phase shift amount setting value is 7 bits, and the intensity setting value is 5 bits. That is, 12-bit information is stored in each address of the memory 13.

The memory 13 is, for example, a static random access memory (SRAM). It is preferable to use SRAM for the memory 13, but a register may be used therefor. That is, a dynamic random access memory (DRAM), a flash memory, or a read only memory (ROM) may be used for the memory 13.

In addition to the above-described beam table BT, the memory 13 also stores on-chip beam calculation (OCC). The OCC is a function of automatically calculating a required phase parameter on a beam forming IC (BFIC) according to a user-set angle and providing a required phase to each RF front end, and can perform circular polarization in more angles (for example, 65536 patterns) than the beam table BT.

The analog circuit portion 12 is a circuit that outputs an RF signal to the antenna element a connected to the RF front end 5 or receives the RF signal output from the antenna element a. Under control of the digital circuit portion 11, the analog circuit portion 12 adjusts a phase and intensity of the RF signal transmitted and received to and from the antenna element a connected to the RF front end 5.

The analog circuit portion 12 is connected to the analog circuit 7 through the RF signal coupler/splitter 8. The RF signal coupler/splitter 8 distributes the RF signal output from the analog circuit 7 to the analog circuit portions 12 provided in each of the RF front ends 5A to 5P.

As shown in FIG. 3, the analog circuit portion 12 includes a phase shifter (PS) 61, a switch (SW) 62, a variable gain amplifier (VGA) 63, a phase inverter (PI) 64, a power amplifier (PA) 65, a switch (SW) 66, a low-noise amplifier (LNA) 67, a variable gain amplifier (VGA) 68, and a phase inverter (PI) 69.

The variable gain amplifier 63, the phase inverter 64, and the power amplifier 65 are provided on a transmission path R1, and the low-noise amplifier 67, the variable gain amplifier 68, and the phase inverter 69 are provided on a reception path R2. The transmission path R1 is a path through which the RF signal (high frequency signal) output to the antenna element a passes, and the reception path R2 is a path through which the RF signal (high frequency signal) input from the antenna element a passes.

The switches 62 and 66 switch to connect to the transmission path R1 or to connect to the reception path R2 between the phase shifter 61 and the antenna element a at a defined time interval. Accordingly, the phased array antenna module A can perform transmission and reception as a time-division multiplexing system.

The phase shifter 61 adjusts a phase shift amount of the RF signal passing through the transmission path R1 or the RF signal passing through the reception path R2, according to a phase shift amount setting value of the beam table BT read from the memory 13 of the digital circuit portion 11. That is, the phase shifter 61 is commonly provided to the transmission path R1 and the reception path R2. A configuration may be adopted in which the phase shifter 61 common to the transmission path R1 and the reception path R2 is omitted and phase shifters are individually provided on the transmission path R1 and the reception path R2.

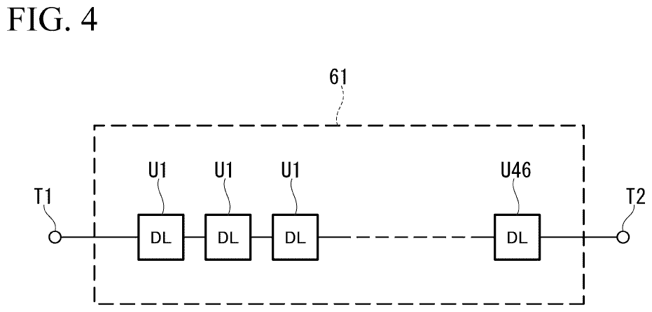

The phase shifter 61 has, for example, a detailed configuration shown in FIG. 4. That is, the phase shifter 61 includes a pair of input/output terminals T1 and T2 and 46 delay units U1 to U46. As shown in FIG. 4, the phase shifter 61 is provided in a state where 46 delay units U1 to U46 are connected in series between a pair of input/output terminals T1 and T2.

Each of the delay units U1 to U46 imparts the same unit delay amount to the RF signal. The unit delay amount is a unit phase shift amount corresponding to, for example, 5.5° when converted into a phase of the RF signal. Each of the delay units U1 to U46 is switched between an ON state and an OFF state based on a switching signal input from the digital circuit portion 11. A unit delay amount in the delay units U1 to U46 corresponds to a phase adjustment resolution in the present invention.

The ON state is an operation state in which the unit delay amount is imparted to the RF signal. On the other hand, the OFF state is an operation state in which the unit delay amount is not imparted to the RF signal. That is, the phase shifter 61 in the present embodiment can impart a delay time (phase shift amount) over a range of 0 to 46 times the unit delay amount to the RF signal with a resolution of the unit delay amount (unit phase shift amount).

The unit phase shift amount is a control parameter that controls a resolution in setting a beam direction of radio waves (transmission waves and reception waves) transmitted and received to and from the array antenna 1. That is, the less the unit phase shift amount, the more finely the beam direction of the array antenna 1 can be set. On the other hand, in a case where the unit phase shift amount is relatively large, a set of a beam direction becomes rough.

The phase shifter 61 corresponds to a first phase adjuster in the present invention. The phase shifter 61 is a phase adjuster that adjusts a phase of the RF signal with the above-described unit delay amount (unit phase shift amount) as a phase adjustment resolution and has a relatively small phase adjustment resolution. A mounting area of the phase shifter 61 is relatively large because a phase needs to be set in small steps by a unit delay amount (unit phase shift amount).

The variable gain amplifier 63 amplifies the RF signal passing through the transmission path R1, according to an intensity setting value of the beam table BT which is read from the memory 13. The phase inverter 64 inverts a phase of the RF signal passing through the transmission path R1, according to a phase shift amount setting value of the beam table BT which is read from the memory 13. The power amplifier 65 amplifies the RF signal passing through the transmission path R1 at a predetermined amplification rate. By adjusting the phase shift amount and intensity of the RF signal passing through the transmission path R1, a beam direction of a radio wave (transmission wave) radiated from the array antenna 1 can be changed.

The low-noise amplifier 67 amplifies the RF signal output from the switch 66 at a predetermined amplification rate. The variable gain amplifier 68 amplifies the RF signal passing through the reception path R2, according to the intensity setting value of the beam table BT which is read from the memory 13.

The phase inverter 69 inverts a phase of the RF signal passing through the reception path R2, according to a phase shift amount setting value of the beam table BT which is read from the memory 13. By adjusting the phase shift amount and the intensity of the RF signal passing through the reception path R2, a beam direction of a radio wave (reception wave) received by the array antenna 1 can be changed.

The above-described phase inverters 64 and 69 correspond to second phase adjusters in the present invention. The phase inverters 64 and 69 adjust a phase of the RF signal to 0° or 180°, and phase adjustment resolutions of the phase inverters 64 and 69 are larger than the phase adjustment resolution of the phase shifter 61. That is, the phase inverters 64 and 69 are phase adjusters, each having a relatively large phase adjustment resolution. Since the phase inverters 64 and 69 do not need to set a phase in small steps as in the phase shifter 61, a mounting area thereof is extremely small compared to a mounting area of the phase shifter 61.

Here, details will be described below, but the phased array antenna module A according to the present embodiment transmits and receives radio waves (transmission waves and reception waves) of right circularly polarized radio waves or left circularly polarized radio waves, and sets beam directions of the transmission waves and the reception waves to predetermined directions.

The above-described beam former integrated circuit 2 performs predetermined phase shift processing and amplitude processing on the RF signal (transmission signal) input from the frequency conversion integrated circuit 3 through the RF signal coupler/splitter 4 to supply power to each of the 128 antenna elements a, thereby radiating a right circularly polarized or left circularly polarized transmission wave, in which a beam direction is set as a predetermined direction, from the array antenna 1.

In addition, the beam former integrated circuit 2 generates an RF signal (reception signal) by performing predetermined amplitude processing and phase shift processing on element reception signals of right circularly polarized or left circularly polarized reception waves which are propagated from a predetermined direction and received by 128 antenna elements in the array antenna 1. The beam former integrated circuit 2 outputs the reception signal generated in this way to the frequency conversion integrated circuit 3 and the control device C through the RF signal coupler/splitter 4.

In the beam former integrated circuit 2, the phase shifter 61, the phase inverter 64, and the phase inverter 69 correspond to a phase adjuster in the present invention. That is, the phase shifter 61 and the phase inverter 69 adjust phases of the transmission signal (RF signal) supplied to each of the plurality of antenna elements a and the reception signal (RF signal) output from each of the plurality of antenna elements a.

In addition, the phase shifter 61 and the phase inverter 69 set beam directions of a transmission wave and a reception wave based on the phase adjustment, and perform setting of the transmission wave to a circularly polarized wave (a right circularly polarized wave or a left circularly polarized wave) and setting for receiving the reception wave as a circularly polarized wave (a right circularly polarized wave or a left circularly polarized wave).

For example, the phase shifter 61 and the phase inverter 64 adjust a phase of transmission signals (RF signals) supplied to the respective antenna elements a based on the beam table BT. The phase shifter 61 and the phase inverter 64 set a polarization plane of the transmission wave to a right circularly polarized wave or a left circularly polarized wave and set a beam direction of the transmission wave to a predetermined direction, based on the phase adjustment of the transmission signal.

In addition, the phase shifter 61 and the phase inverter 69 adjust phases of the reception signals (RF signals) received from the respective antenna elements a based on the beam table BT. That is, the phase shifter 61 and the phase inverter 69 perform setting for receiving a polarization plane of the reception wave as a right circularly polarized wave or a left circularly polarized wave and set a beam direction of the reception wave to a predetermined direction, based on the phase adjustment of the reception signal.

In addition, in the beam former integrated circuit 2, the analog circuit 7 performs predetermined analog signal processing on an IF signal input from the control device C through the signal line B1 and outputs the IF signal to the RF signal coupler/splitter 8. In addition, the analog circuit 7 performs predetermined analog signal processing on the reception signal input from the RF signal coupler/splitter 8 and outputs the reception signal to the signal line B1.

The RF signal coupler/splitter 8 in the beam former integrated circuit 2 distributes the IF signal input from the analog circuit 7 to each of the RF front ends 5A to 5P. In addition, the RF signal coupler/splitter 8 couples (adds) the RF signals output from the analog circuit portion 12 of each of the RF front ends 5A to 5P and outputs the RF signals to the analog circuit 7.

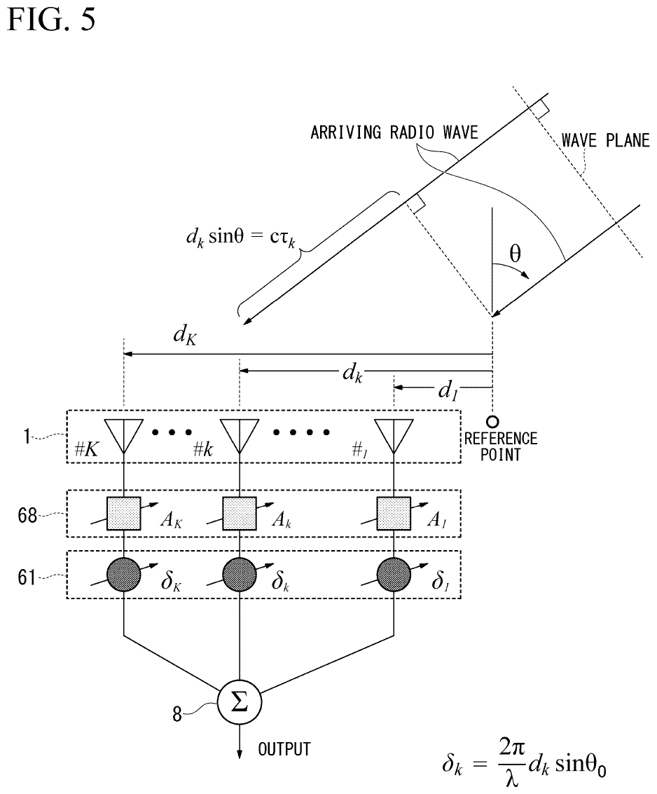

Next, an operation and performance of the phased array antenna module A according to the present embodiment will be described in detail with reference to FIGS. 5 to 9B.

FIG. 5 is a schematic diagram showing a setting principle of a beam direction in the phased array antenna module A. In FIG. 5, a reception state of an arriving radio wave (reception wave) being propagated from the outside is shown as an example. In addition, a setting principle of a beam direction in the present embodiment is the same as the principle described in the above-described Japanese Patent No. 7133532.

In addition, in FIG. 5, in the array antenna 1, K antenna elements that are linearly arranged in the horizontal direction or the vertical direction are denoted by #1 to #K. In addition, in FIG. 5, distances from reference points of the K antenna elements #1 to #K are denoted by d₁ to d_{K}. A travel direction of an arriving radio wave (reception wave), that is, a beam direction is a direction in which K antenna elements are inclined by an angle θ with respect to an orthogonal direction of an arrangement direction of #1 to #K. That is, a wave plane of the arriving radio wave is in an orthogonal direction of the angle θ as shown.

In addition, in FIG. 5, amplification degrees of the variable gain amplifiers 68 connected to the K antenna elements #1 to #K are denoted by A₁ to A_{K}. Further, in FIG. 5, phase shift amounts of the phase shifters 61 connected to the K antenna elements #1 to #K are denoted by δ₁ to δ_{K}.

A travel distance difference between arriving radio waves in the K antenna elements #1 to #K is represented by dₖsinθ=cτₖ as shown in a case where the k-th antenna element is denoted by #k. Here, “c” is a propagation speed of the arriving radio wave and is a light speed. In a case where the arriving radio wave is received with the highest intensity by considering such a travel distance difference, a phase shift amount δₖ of the phase shifter 61 connected to the k-th antenna element #k can be represented by an equation to be shown in a case where a wavelength of the arriving radio wave is denoted by λ.

In the phased array antenna module A according to the present embodiment, a phase shift amount of the phase shifter 61 of each of the 16 RF front ends 5A to 5P connected to the array antenna 1 is adjusted to satisfy such a reception condition.

The equation in FIG. 5 is also applied during a transmission operation of the phased array antenna module A. That is, the phased array antenna module A sets a beam direction to the angle θ when a transmission wave is radiated from the array antenna 1 by adjusting a phase shift amount of each of the phase shifters 61 in the 16 RF front ends 5A to 5P based on the equation in FIG. 5.

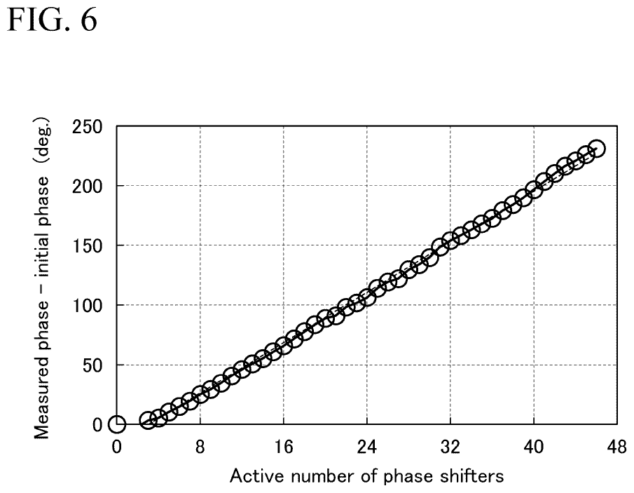

FIG. 6 is a characteristic diagram showing phase characteristics of each phase shifter 61. As described above, in each phase shifter 61, the plurality (46) of delay units U1 to U46 are connected in series, and an ON state and an OFF state can be switched and set freely. That is, as shown in FIG. 6, phase shift amounts of the respective phase shifters 61 are discretely set with a step width of a unit phase shift amount.

That is, in the phased array antenna module A according to the present embodiment, a phase shift amount of each of the phase shifters 61 in the 16 RF front ends 5A to 5P is set based on a switching signal input from the digital circuit portion 11, and thereby, beam directions of a reception wave and a transmission wave are set.

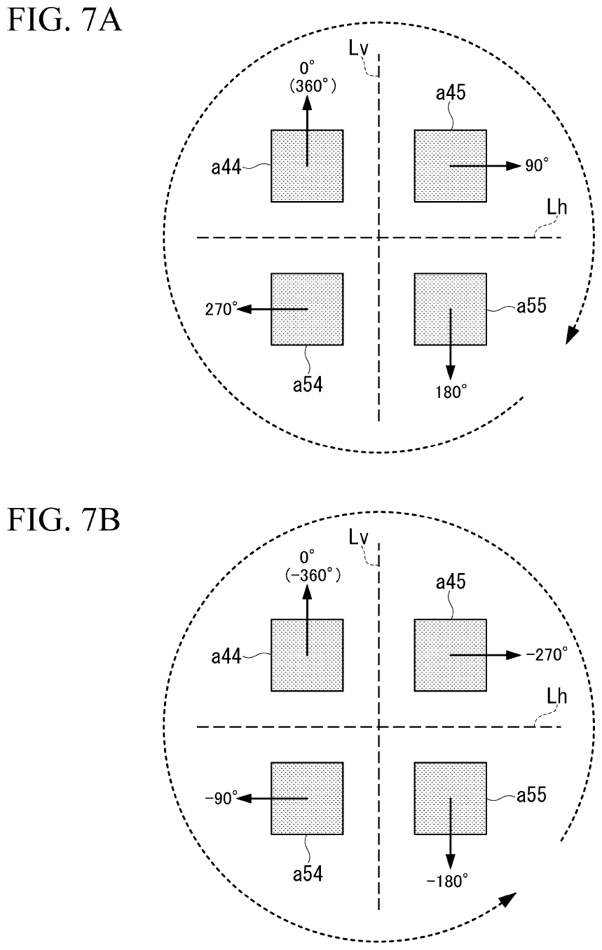

In addition, the phased array antenna module A according to the present embodiment transmits and receives circularly polarized waves (right circularly polarized waves and/or left circularly polarized waves) in addition to the transmission and reception of linearly polarized waves. FIGS. 7A and 7B are schematic diagrams showing a generation principle of circularly polarized waves in the phased array antenna module A. The generation principle of the circularly polarized waves in the present embodiment is the same as the principle described in Japanese Patent No. 7133532.

In FIGS. 7A and 7B, among the 11th to 88th antenna elements a11 to a88 shown in FIG. 2, four antenna elements adjacent to an intersection of a horizontal center line Lh and a vertical center line Lv, that is, the 44th antenna element a44, the 45th antenna element a45, the 54th antenna element a54, and the 55th antenna element a55 are taken as an example to show the generation principle of the circularly polarized waves.

A generation condition of circularly polarized waves in the 44th antenna element a44, the 45th antenna element a45, the 54th antenna element a54, and the 55th antenna element a55 is to provide a phase difference of 90° in the 44th antenna element a44, the 45th antenna element a45, the 54th antenna element a54, and the 55th antenna element a55.

For example, in a case where right circularly polarized transmission waves are radiated from the 44th antenna element a44, the 45th antenna element a45, the 54th antenna element a54, and the 55th antenna element a55, and in a case where a phase of the RF signal supplied to the 44th antenna element a44 is set to a reference phase 0° as shown in FIG. 7A, a phase of the RF signal supplied to the 45th antenna element a45 needs to be set to 90°. In addition, it is necessary to set a phase of the RF signal supplied to the 55th antenna element a55 to 180° and to set a phase of the RF signal supplied to the 54th antenna element a54 to 270°.

In addition, in a case where the left circularly polarized transmission wave is radiated from the 44th antenna element a44, the 45th antenna element a45, the 54th antenna element a54, and the 55th antenna element a55, and in a case where the phase of the RF signal supplied to the 44th antenna element a44 is set to the reference phase 0° as shown in FIG. 7B, the phase of the RF signal supplied to the 54th antenna element a54 needs to be set to −90°. In addition, it is necessary to set the phase of the RF signal supplied to the 55th antenna element a55 to −180°and to set the phase of the RF signal supplied to the 45th antenna element a45 to −270°.

That is, to generate a circularly polarized transmission wave, it is necessary to adjust the phase of the RF signal over 0° to 360°. In the phased array antenna module A according to the present embodiment, the phase adjustment of 0° to 360° required for generating the circularly polarized waves is performed by each of the phase shifters 61, the phase inverters 64, and the phase inverters 69 provided in the 16 RF front ends 5A to 5P described above.

Here, a maximum phase change amount of the phase shifter 61 is, for example, about 240°. Therefore, in the phased array antenna module A according to the present embodiment, by providing the phase inverter 64 and the phase inverter 69 in addition to the phase shifter 61, a generation condition of a circularly polarized wave is satisfied. Since the phase inverter 69 can impart a phase change of 0° or 180 degrees to an RF signal, a generation condition of circularly polarized waves can be satisfied by providing the phase shifter 61, the phase inverter 64, and the phase inverter 69.

The generation condition of the circularly polarized waves can be satisfied by increasing the number of delay units in the phase shifter 61 to 46 or more, but, in this case, a mounting area of the phase shifter 61 in the beam former integrated circuit 2 increases. As described above, since 16 RF front ends 5A to 5P are mounted on each of the eight beam former integrated circuits 2A to 2H, when a mounting area of the phase shifter 61 in each of the RF front ends 5A to 5P increases, it is difficult to mount the eight beam former Integrated circuits 2A to 2H in the phased array antenna module A having a defined size.

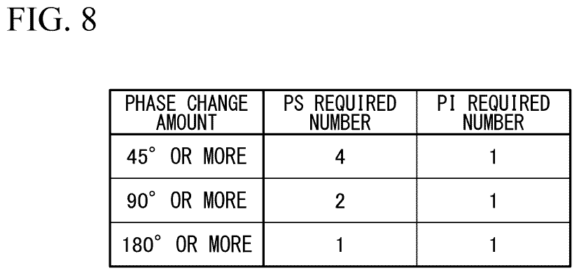

FIG. 8 is a table showing a PS required number (the required number of phase shifters) and a PI required number (the required number of phase inverters) according to a phase change amount. The PS required number and the PI required number depend on a maximum phase change amount of the phase shifter 61, but change according to the phase change amount as shown. As shown in FIG. 8, in a case where the PI required number is “1”, the PS required number is “4” in a case where the phase change amount of the phase shifter 61 is 45° or more, is “2” in a case where the phase change amount of the phase shifter 61 is 90° or more, and is “1” in a case where the phase change amount of the phase shifter 61 is 180° or more. That is, the larger the phase change amount of the phase shifter 61, the smaller the PS required number.

The phased array antenna module A according to the present embodiment includes a plurality of antenna elements a that radiate transmission waves and capture reception waves, and the phase shifter 61, the phase inverter 64, and the phase inverter 69 (phase adjuster) that set beam directions of the transmission waves and the reception waves by adjusting phases of transmission signals (RF signals) supplied to the plurality of antenna elements a and phases of reception signals (RF signals) output from the plurality of antenna elements a and set polarization planes of the transmission waves and the reception waves to circularly polarized waves (right circularly polarized waves and left circularly polarized waves).

In addition, in the phased array antenna module A, the phase adjuster includes the phase shifter 61 (first phase adjuster) having a relatively small phase adjustment resolution and a relatively large mounting area, and the phase inverter 64 and the phase inverter 69 (second phase adjuster) having a relatively large phase adjustment resolution and a relatively small mounting area.

The phased array antenna module A implements circular polarizations (a right circular polarization and a left circular polarization) and beam forming by combining the phase inverter 64 and the phase inverter 69 (second phase adjuster) having a relatively small mounting area with the phase shifter 61 (first phase adjuster) having a relatively large mounting area. According to the present embodiment, it is possible to provide the phased array antenna module A that can save a mounting area.

In addition, in the phased array antenna module A according to the present embodiment, the first phase adjuster is the phase shifter 61 in which the plurality of delay units U1 to U46 to which unit delay amounts are imparted are connected in series to each other, and each of the delay units U1 to U46 is switched between an ON state in which the unit delay amount is imparted and an OFF state in which the unit delay amount is not imparted.

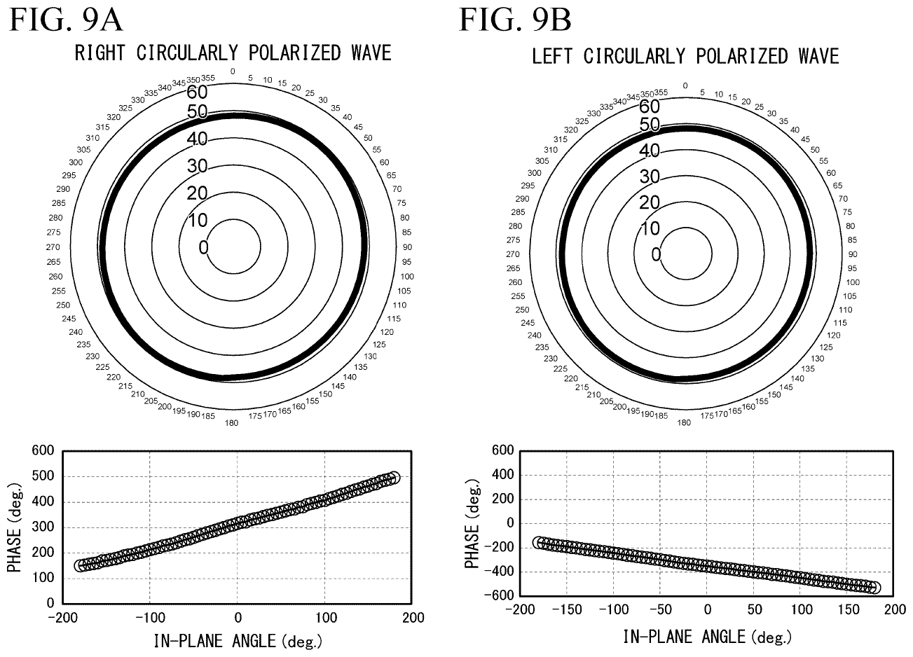

According to the present embodiment, it is possible to implement a circular polarization of an excellent axial ratio as shown in FIGS. 9A and 9B. Since the phase shifter 61 in the present embodiment employs a configuration in which an ON state and an OFF state of the plurality (46) of delay units U1 to U46 connected in series to each other are switched, an amplitude of an RF signal is hardly changed.

That is, the phase shifter 61 in the present embodiment can finely adjust a phase shift amount for an RF signal and hardly change an amplitude of the RF signal when switching between an ON state and an OFF state. Therefore, according to the present embodiment, it is possible to provide the phased array antenna module A in which an axial ratio is extremely close to “1”.

In addition, in the phased array antenna module A according to the present embodiment, the second phase adjuster is the phase inverter 64 and the phase inverter 69. According to the present embodiment, it is possible to implement the second phase adjuster having a relatively large phase adjustment resolution in a simple configuration, that is, in a state where a mounting area is saved.

In addition, in the phased array antenna module A according to the present embodiment, the antenna element a includes an antenna element for horizontal polarization and an antenna element for vertical polarization. According to the present embodiment, it is possible to easily implement a circularly polarized wave.

In addition, in the phased array antenna module A according to the present embodiment, the plurality of antenna elements a are orthogonally arranged in a horizontal direction and a vertical direction. According to the present embodiment, it is possible to easily implement a circular polarization and beam forming.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

For example, the following modification examples are considered.

(1) Although the above-described embodiments describe the phased array antenna module A that performs both radiation of a transmission wave and capture of a reception wave, the present invention is not limited thereto. That is, the present invention can be applied to a phased array antenna module that performs any one or both of the radiation of the transmission wave and the capture of the reception wave.

(2) Although, in the above-described embodiments, the first phase adjuster is configured by the phase shifter 61 including the plurality of delay units U1 to U46, the present invention is not limited thereto. The first phase adjuster having a configuration different from a configuration of the phase shifter 61 may be employed.

(3) Although the above-described embodiments employ the phase inverter 64 and the phase inverter 69 as the second phase adjuster, the present invention is not limited thereto. That is, as long as a phase adjustment resolution of the second phase adjuster is larger than a phase adjustment resolution of the first phase adjuster, the second phase adjuster is not limited to the phase inverter 69 that switches a phase of an RF signal between 0° and 180°. For example, a phase adjuster that switches the phase of the RF signal every 90° may be employed as the second phase adjuster.

(4) Although the above-described embodiments employ the antenna element a including an antenna element for horizontal polarization and an antenna element for vertical polarization, the present invention is not limited thereto. For example, the antenna element a may be configured by a single antenna element.

(5) Although the above-described embodiments employ the array antenna 1 in which the plurality of antenna elements a are orthogonally arranged in a horizontal direction and a vertical direction, the present invention is not limited thereto. The plurality of antenna elements a may have an arrangement aspect other than the orthogonal arrangement.

What is claimed is:

1. A phased array antenna module comprising:
a plurality of antenna elements configured to perform any one or both of radiation of a transmission wave and capture of a reception wave; and
a phase adjuster configured to set a beam direction of any one or both of the transmission wave and the reception wave by adjusting a phase of any one or both of a transmission signal supplied to each of the plurality of antenna elements and a reception signal output from each of the plurality of antenna elements, and to perform any one or both of setting of the transmission wave to a circularly polarized wave and setting for receiving the reception wave as the circularly polarized wave,
wherein the phase adjuster includes a first phase adjuster and a second phase adjuster,
a phase adjustment resolution of the first phase adjuster is smaller than a phase adjustment resolution of the second phase adjuster, and
a mounting area of the first phase adjuster is larger than a mounting area of the second phase adjuster.

2. The phased array antenna module according to claim 1,
wherein, in the first phase adjuster, a plurality of delay units that impart a unit delay amount are connected in series, and
the delay unit is switched between a state in which the unit delay amount is imparted and a state in which the unit delay amount is not imparted.

3. The phased array antenna module according to claim 1,
wherein the second phase adjuster is a phase inverter.

4. The phased array antenna module according to claim 1,
wherein the antenna element includes an antenna element for horizontal polarization and an antenna element for vertical polarization.

5. The phased array antenna module according to claim 1,
wherein the plurality of antenna elements are orthogonally arranged in a horizontal direction and a vertical direction.

6. The phased array antenna module according to claim 2,
wherein the second phase adjuster is a phase inverter.

7. The phased array antenna module according to claim 2,
wherein the antenna element includes an antenna element for horizontal polarization and an antenna element for vertical polarization.

8. The phased array antenna module according to claim 2,
wherein the plurality of antenna elements are orthogonally arranged in a horizontal direction and a vertical direction.
